(19) United States
(12) Patent Application Publication
(10) Pub. No.: US 2026/0236973 A1
(43) Pub. Date: Aug. 13, 2026

(54) Cruise Clothing Rental System

(71) Applicant: Gang woo Pyo, Gyeryong-si (KR)

(72) Inventor: Gang woo Pyo, Gyeryong-si (KR)

(21) Appl. No.: 19/048,862

(22) Filed: Feb. 8, 2025

(51) Int. Cl. G06Q 30/0601; G06Q 10/08; G06Q 30/0202

(52) U.S. Cl. CPC G06Q 30/0631; G06Q 10/08; G06Q 30/0202

(57) ABSTRACT

The present invention relates to a Cruise Clothing Rental System that integrates AI-based outfit recommendations, RFID tracking, UV-C sterilization, and IoT logistics optimization to provide a convenient, hygienic, and sustainable clothing rental service for cruise passengers.

This system synchronizes with cruise booking platforms, allowing passengers to pre-select rental clothing based on their itinerary, weather forecasts, and personal preferences. Each rental garment is tracked via RFID technology, ensuring real-time inventory management. The system also incorporates Smart Wardrobes in passenger cabins, which feature RFID scanning, UV-C sterilization, and climate-controlled compartments to maintain hygiene and garment quality.

At the end of the cruise, passengers leave rental garments in their cabins, where an Automated Return System collects, sorts, cleans, and redistributes them. This process eliminates the need for packing, reduces baggage fees, and supports a circular fashion economy.

The invention enhances passenger convenience while promoting sustainability by reducing textile waste and logistical inefficiencies associated with traditional travel clothing.

### 2-2 BACKGROUND OF THE INVENTION

### (a) Field of the Invention

The invention relates to a smart clothing rental system for cruise passengers, integrating AI-based recommendations, RFID tracking, UV-C sterilization, and IoT logistics.

### (b) Description of Related Art

Existing systems lack integration of AI-driven cruise-specific outfit recommendations, automated RFID logistics for garment circulation, and smart wardrobes with hygiene features. Prior art includes fragmented solutions for hotel linen tracking (U.S. Pat. No. 9,876,543) and personal wardrobe management (U.S. Pat. No. 10,123,456), but none address the unique challenges of cruise travel.

### 2.4 SUMMARY OF THE INVENTION

The invention provides a comprehensive clothing rental system for cruise passengers, comprising:
AI Recommendation Engine: Analyzes passenger data, weather, and dress codes using ResNet-50.
RFID Logistics: Tracks garments from suppliers to cabins and automated returns.
Smart Wardrobe: Features RFID scanning, UV-C sterilization, and climate control.
Automated Return System: Enables contactless garment collection and redistribution.

### 2.5 BRIEF DESCRIPTION OF THE DRAWINGS

FIG. 1: Flowchart of AI recommendation system

(ResNet-50 processing passenger/weather data).

FIG. 2: RFID logistics tracking (garment lifecycle from suppliers to redistribution).

FIG. 3: Smart wardrobe internal structure (RFID, UV-C, climate control).

FIG. 4: End-to-end rental process (booking to return).

FIG. 5: Automated return system workflow.

FIG. 6: Mobile app interface (AR preview, inventory tracking).

### 2-6 DETAILED DESCRIPTION OF THE INVENTION

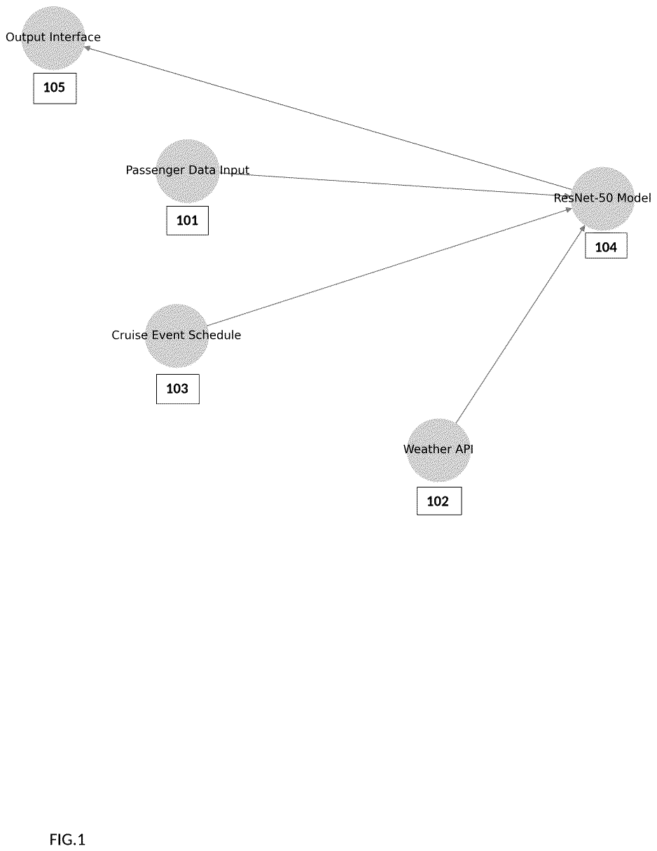

### FIG. 1: AI Recommendation System Flowchart

Description: Illustrates the AI-driven process for generating outfit recommendations.

### Components:

101. Passenger Data Input (body measurements, style preferences).
102. Weather API (real-time temperature, humidity, precipitation at cruise destinations).
103. Cruise Event Schedule (formal dinners, shore excursions).
104. ResNet-50 Model processing inputs to generate recommendations.
105. Output Interface displaying recommended outfits on mobile app.

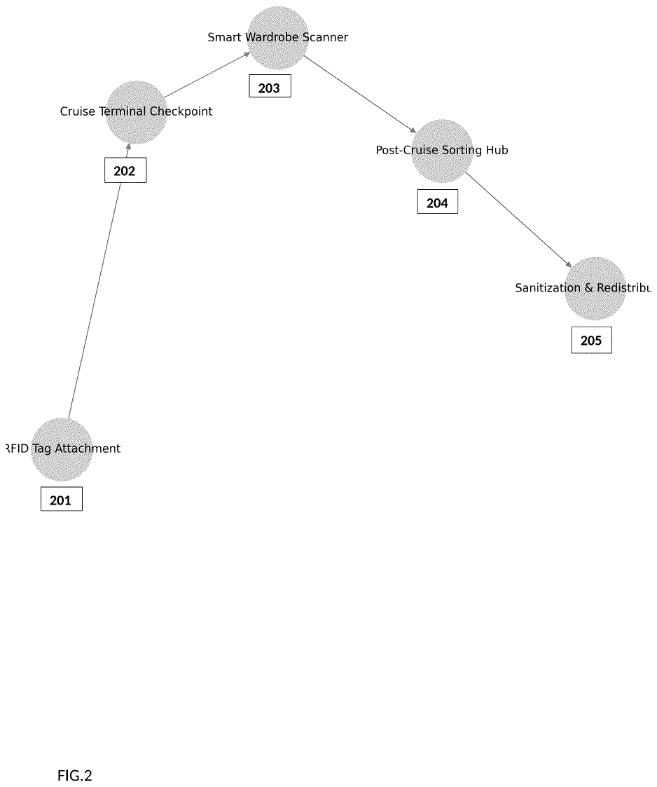

### FIG. 2: RFID-Based Logistics Tracking Diagram

Description: Garment lifecycle from supplier to redistribution. Components:
201. RFID Tag Attachment at supplier facility.
202. Cruise Terminal RFID Checkpoint (verifies delivery).
203. Smart Wardrobe RFID Scanner (cabin-level tracking).
204. Post-Cruise Sorting Hub (automated return processing).
205. Sanitization & Redistribution (cleaned garments re-entering inventory).

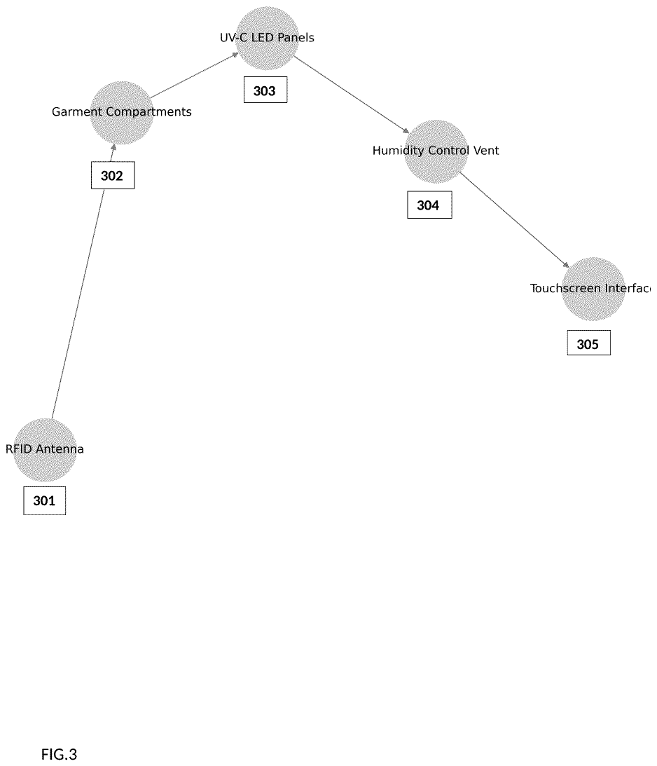

### FIG. 3: Smart Wardrobe Internal Structure

Description: Cross-sectional view of the cabin-installed wardrobe. Components:
301. RFID Antenna Array (scans garments upon insertion).
302. Garment Compartments (climate-controlled zones).
303. UV-C LED Panels (sterilizes garments during storage).
304. Humidity Control Vent (adjusts based on fabric type).
305. Touchscreen Interface (displays outfit suggestions).

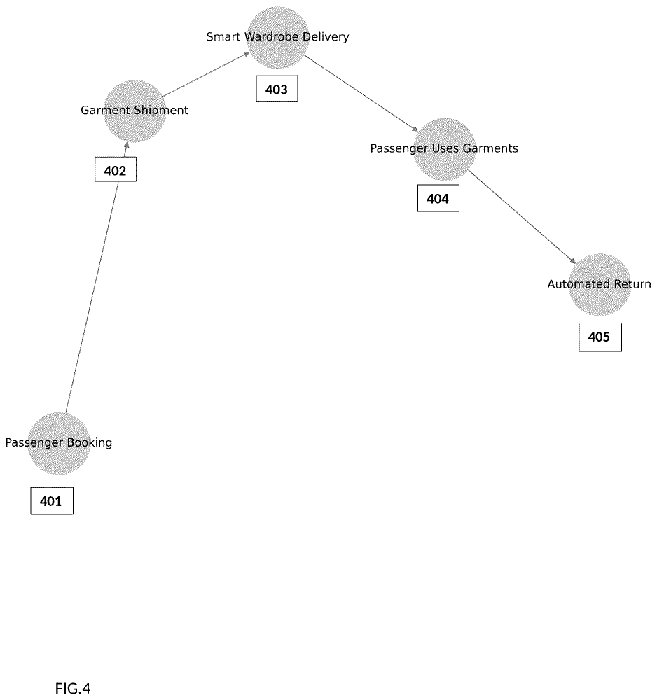

### FIG. 4: End-to-End Rental Process Flow

Description: Sequence diagram of the rental workflow. Steps:
401. Passenger books cruise and selects outfits via mobile app.
402. Garments shipped to cruise terminal via IoT-optimized logistics.
403. Smart Wardrobe syncs with RFID system for delivery.
404. Passenger uses garments during the cruise.
5. Post-cruise automated return via RFID-triggered collection.

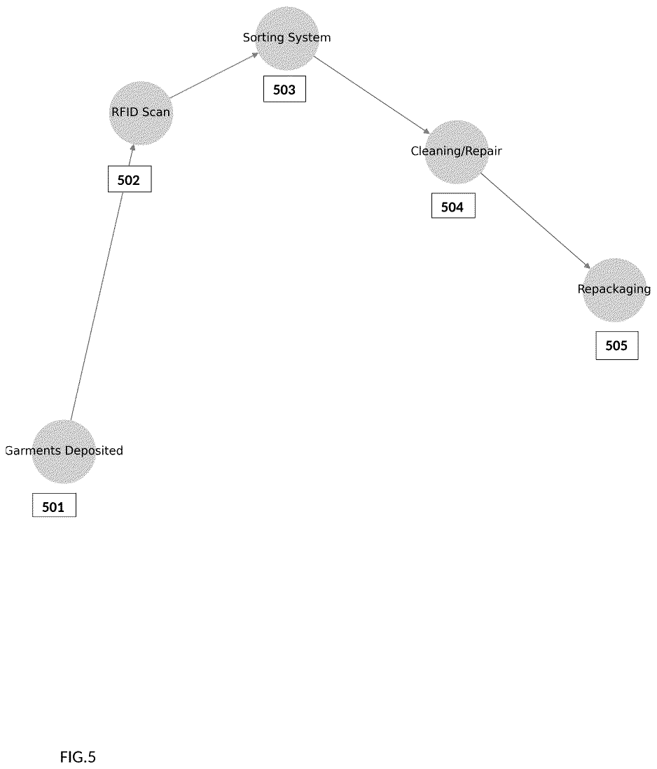

### FIG. 5: Automated Return System Workflow

Description: Logic flow for post-cruise garment handling. Steps:
501. Garments deposited in cabin return bin.
502. RFID scan confirms item identity and condition.
503. Sorting System—A system for sorting garments into appropriate cleaning or repair procedures, utilizing data obtained from the RFID scan.
504. Conveyor system routes garments to cleaning or repair.
505. Sanitized garments repackaged for next rental cycle.

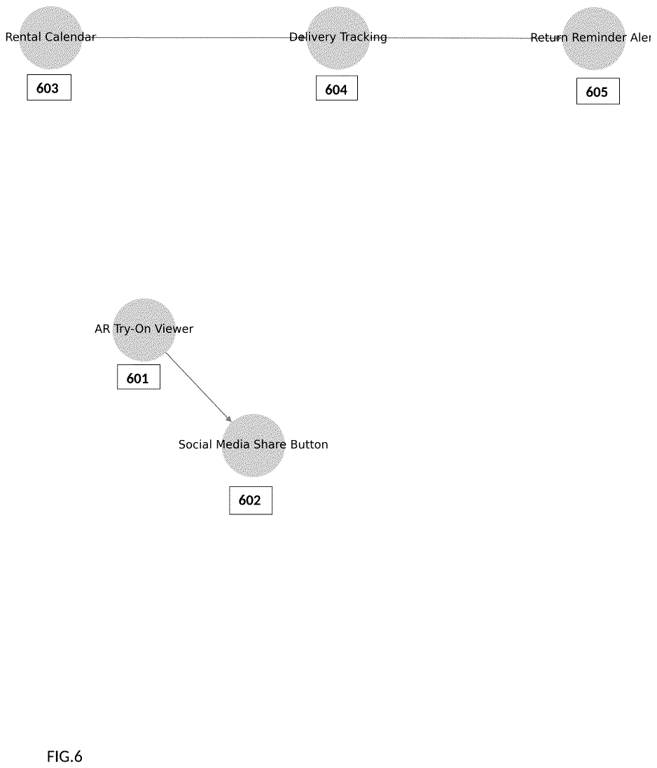

### FIG. 6: Mobile App Interface Schematic

Description: Wireframe of passenger-facing app features. Components:
601. AR Try-On Viewer (overlays outfits on user avatar).
602. . . . Social Media Share Button (posts outfits to Instagram/Facebook).
603. Rental Calendar (aligns outfits with daily cruise events).
604. Delivery Tracking Dashboard (real-time RFID updates).
605. Return Reminder Alert (countdown to disembarkation).
(a) AI Recommendation Engine

Trained on passenger body measurements, style preferences, and real-time weather using ResNet-50.—Dynamically adjusts recommendations based on cultural norms (e.g., formal dinners, tropical destinations).
(b) RFID Logistics System

RFID tags track garments through delivery, cabin storage, and post-cruise cleaning.—Real-time inventory updates minimize loss and optimize supply chain efficiency.
(c) Smart Wardrobe

UV-C lamps disinfect garments after each use.

Climate control adjusts humidity/temperature based on fabric type (e.g., silk vs. wool).
(d) Automated Returns—Passengers leave garments in cabins; RFID triggers sorting, cleaning, and redistribution.

1. A cruise clothing rental system, comprising:
(a) AI recommendation engine using ResNet-50;
(b) RFID logistics tracking garments from suppliers to cabins;
(c) Smart wardrobe with RFID, UV-C, and climate control;
(d) Automated return system for garment redistribution.

2: AI updates recommendations based on real-time weather.

3: Smart wardrobe adjusts climate by fabric type.

4: AR preview for virtual try-ons.

5: RFID tracks garment wear for replacement cycles.

6: AI incorporates cultural dress codes.

7: The system of claim 1, further comprising a social media integration module configured to:
(a) Provide an interface within the mobile application that enables users to virtually try on rented garments using augmented reality (AR) technology and share the images or videos directly on social media platforms, including but not limited to Instagram, Facebook, and TikTok;
(b) Collect and analyze rental trends for cruise events and generate AI-based recommendations that dynamically update based on real-time data from user preferences and trending styles;
(c) Store anonymized user engagement data related to shared outfit selections in a database, allowing the AI recommendation engine to optimize rental trends and improve future outfit suggestions based on collective user preferences and social engagement metrics.

8: The system of claim 1, further comprising an automated return system that includes a garment recycling and sustainability function, wherein the system is configured to:
(a) Scan and assess the condition of returned garments using RFID tags to evaluate wear level, contamination status, and reusability through an automated inspection system;
(b) Integrate an AI-based garment recycling assessment engine that categorizes garments upon return into the following classifications:
(i) Garments eligible for direct reuse after standard cleaning and sterilization,
(ii) Garments requiring minor repairs before being reintroduced into the rental cycle,
(iii) Garments deemed unfit for reuse, which are directed to upcycling or textile recycling processes;
(c) Sort and separate garments identified for upcycling or textile recycling, ensuring they are processed for material repurposing and integration into new fabric production supply chains;
(d) Store and maintain garment recycling and sustainability records in a database, providing users with access to sustainability reports through the mobile application, thereby promoting environmental consciousness and corporate social responsibility.

9: The system of claim 1, further comprising a mobile application configured to:
(i) notify passengers of garment delivery status via push notifications,
(ii) display real-time inventory of available garments, and
(iii) issue automated reminders for garment returns prior to cruise disembarkation.

10: The system of claim 1, wherein the RFID-based logistics system is further configured to:
(i) track rental duration for each garment,
(ii) assess garment condition using RFID sensor data, and
(iii) flag non-compliant returns for manual inspection.

11: The system of claim 1, further comprising an RFID-based hygiene management module configured to:
(a) Maintain a cloud-based hygiene tracking database that records the washing and sterilization history of each garment using RFID-tagged data;
(b) Verify the completion of UV-C sterilization processes in smart wardrobes by scanning garments with RFID readers, triggering an alert if sterilization is incomplete or unsuccessful;
(c) Provide cruise operators with real-time monitoring of hygiene status across all rental garments, generating automatic alerts when garments exceed a predetermined number of rental cycles or require mandatory sanitation based on their usage history;
(d) Execute an automated cleanliness inspection when garments are returned, utilizing RFID-enabled scanning to detect contamination levels and employing an AI-driven sorting system to determine the appropriate sanitization process, whether through washing, UV-C sterilization, or quarantine for specialized treatment.

12: The system of claim 1, further supporting multi-user account functionality to allow group reservations, wherein the AI recommendation engine coordinates outfit selections across multiple passengers within a shared itinerary. **claim 13**: The system of claim 1, wherein the AI recommendation engine applies neural style transfer algorithms to adapt recommended outfits to match passengers' preferred color palettes and stylistic patterns. **claim 14**: The system of claim 1, wherein the AI recommendation engine utilizes reinforcement learning to iteratively improve outfit selection accuracy based on passenger feedback and historical rental data.

13: The system of claim 1, wherein the AI recommendation engine utilizes neural style transfer techniques to adjust outfit selections based on individual passengers' preferred colors and fashion styles.

14: The system of claim 1, wherein machine learning algorithms continuously refine the recommendation engine, improving outfit selection accuracy based on passenger feedback and historical rental data.

15: The system of claim 1, wherein the centralized data platform stores rental patterns, enabling cruise operators to analyze passenger clothing preferences and optimize future rental offerings using big data analytics.
